(19) United States
(12) Patent Application Publication
(10) Pub. No.: US 2005/0258375 A1
(43) Pub. Date: Nov. 24, 2005

(54) Confocal laser scanning microscopy apparatus

(75) Inventors: Jerome Mertz, Boston, MA (US); Changhuei Yang, Pasadena, CA (US); Laurent Moreaux, Marly La Ville (FR); Thomas Pons, Antony (FR)

Correspondence Address: James R. Williams;Jameson, Seltzer, Harper & Williams, 2625 Wilmington Road, New Castle, PA, 16105, US

(73) Assignee: INSTITUT NATIONAL DE LA SANTE ET DE LA RECHERCHE MEDICALE, Paris (FR)

(21) Appl. No.: 11/042,321

(22) Filed: Jan. 25, 2005

Related U.S. Application Data
(60) Provisional application No. 60/539,254, filed on Jan. 26, 2004.

(51) Int. Cl. G01N 21/64

(52) U.S. Cl. 250/458.1

(57) ABSTRACT

The present invention concerns a confocal laser scanning microscopy apparatus, comprising: means for emitting a laser beam; means for scanning this laser beam in at least two directions onto an observed sample; means for generating a non linear light signal from the transmitted laser light, these non linear light signal generating means being disposed in the light path between the observed sample and detecting means which are adapted for detecting said non linear light signal.

The present invention claims priority to U.S. 60/539254, which was filed on 26 Jan. 2004.

### BACKGROUND OF THE INVENTION

The present invention concerns a confocal laser scanning microscopy apparatus, notably a transmission confocal laser scanning microscopy apparatus.

Such microscopy apparatus exist and are for example described in the U.S. Pat. No. 3,013,467, or in “Theory and Practice of Scanning Optical Microscopy”, Academic press, London, 1984, by T. Wilson and C. Sheppard.

One of the drawbacks of such microscopy apparatus is the need for de-scanning the laser beam since such aparatus comprise a pinhole in the detection path.

### SUMMARY OF THE INVENTION

The present invention improves such known microscopy apparatus by providing a confocal laser scanning microscopy apparatus, comprising
means for emitting a laser beam;
means for scanning this laser beam in at least two directions onto an observed sample;
means for generating a non linear light signal from the transmitted laser light, these non linear light signal generating means being disposed in the light path between the observed sample and detecting means which are adapted for detecting said non linear light signal.

A confocal laser scanning microscopy apparatus according to the invention may further comprise one or more of the following features:
the generating means are second harmonic laser light generating means, and the detecting means are adapted for detecting said second harmonic laser light;
the generating means comprise a second harmonic generating crystal;
the crystal is a Type I, lithium triborate crystal;
the thickness of the crystal along the light path is roughly equal to 200 micrometers;
the lateral dimensions of the crystal are sufficiently large to cover the area scanned by the laser beam;
means for scanning are adapted for scanning the laser in two lateral and one longitudinal directions;
the apparatus further comprises a short-pass filter disposed in the light path immediately behind the non linear light signal generating means such that only non linear light signal is detected;
the non linear light signal generating means comprise a two-photon excited fluorophore;
the non linear light signal generating means comprise a wide-bandgap semiconductor; and
the emitting means are adapted for emitting laser pulses.

### BRIEF DESCRIPTION OF THE DRAWINGS

The invention will be more clearly understood from the following description, given by way of example only, with reference to the accompanying drawings in which:
FIG. 1 represents an experimental layout (where MO=microscope objective. Filter transmits only SHG light);
FIG. 2 represents plots of measured <SHG>/SHG₀ and <P>²/P₀² for z-scan of a 530 nm latex bead (averaged over 5 scans) (Traces are derived from a Gaussian approximation model. Panels illustrate non-averaged SHG (a) and direct P² (b) x-y scan of a bead. Scale bars=5_m);
FIG. 3 represents plots of measured <SHG> and <P>² for a z-scan of a 170_m thick agarose slab of 1_m latex beads, and theoretical trace derived from Gaussian approximation, normalized to arbitrary units;
FIG. 4 represents x-y images of an onion slice under a 200_m agarose slab of 1_m latex beads using SHG detection (left), and direct P² detection (right) (Scale bars=100_m);
FIG. 5 represents a parfocal unit-magnification configuration of a quadratic detection ACM (A scanning laser beam is focused into a sample and re-focused onto a thin SHG crystal. The resulting SHG is isolated (filter) and detected by a photomultiplier tube (PMT));
FIG. 6 represents quadratic detection ACM point spread functions (First order signal responses produced by a point object that is purely absorbing (a: axial; b: radial), or purely phase-shifting (c: axial; radial response is null));
FIG. 7 represents (a) a configuration in which a point object is embedded at a depth L_{A} within a turbid slab of thickness L and (b) an equivalent configuration in which phase variations provoked by slab are projected into appropriate lens pupils;
FIG. 8 represents afilter function H_{L} as a function of normalized spatial frequency ξ_{d} (Ballistic light is attenuated by a factor exp(−Γ_{L}^{(φ)}(0)) (dotted line). Non-ballistic light is transmitted only below the cut-off frequency ξ_{3 dB});
FIG. 9 represents a background ACM signal (closed circles) obtained experimentally when translating a scattering slab in the z direction (slab is centered when z_{slab}=0) (The slab is composed of 1 μm latex beads in agarose (λ=870 nm, Iₛ=39 μm, I*ₛ=490 μm, L=340 μm). Theoretical trace (solid line) from Eq. 35 is shown for comparison);
FIG. 10 represents (a) a Simultaneous TPEF (left) and ACM (right) images of a 500 nm fluorescent latex bead, (b) a corresponding ACM contrast (squares) produced by non-fluorescent beads as a function of penetration depth L_{A} in a scattering medium (λ=870 nm, Iₛ=126 μm, I*ₛ=1800 μm, L=700 μm) consisting of 1 μm diameter non-fluorescent beads, and sparsely distributed 0.5 μm diameter fluorescent beads, (c) an ACM contrast as a function of depth for a different scattering medium (λ=870 nm, Iₛ=39 μm, I*ₛ=490 μm, L=340 μm) (Solid lines are theoretical traces for ACM contrast decay as a function of depth (no free parameters). For reference we illustrate decays of TPEF signal (circles)).

### DETAILED DESCRIPTION OF THE INVENTION

The present invention concerns a transmission-mode confocal scanning laser microscope system based on the use of second harmonic generation (SHG) for signal detection. This method exploits the quadratic intensity dependence of SHG to preferentially reveal unscattered signal light and reject out-of-focus scattered background. The SHG crystal plays the role of a virtual pinhole that remains self-aligned without a need for de-scanning.

Usually, confocal laser scanning microscopy (CLSM) is based on the use of a pinhole in the detection path to provide 3-dimensional image resolution and enhanced background rejection. In the usual CLSM implementation, detected light is de-scanned so that the pinhole effectively tracks the position of the laser focus at the sample. Such de-scanning is readily accomplished in a reflection configuration by retracing the signal path through the laser scanning optics. In a transmission configuration, however, de-scanning is technically much more difficult and typically requires the use of a second synchronized scanning system or of an elaborate beam path to re-direct the transmitted light into the backward direction. We present a simple technique to accomplish self-aligned de-scanning in a transmission CLSM based on signal conversion with a second harmonic generation (SHG) means comprising a crystal.

In standard transmission CLSM, laser light transmitted through the sample is focused onto a pinhole of area A_{P} before detection. If the transmitted light has power P and is distributed over a characteristic area A at the pinhole plane, the detected power scales as PA_{P}/A (assuming A_{P}<A). In our method, the pinhole is replaced by a thin nonlinear crystal and only SHG is detected. Because SHG scales quadratically with incident intensity, the resulting signal scales approximately as P²/A. In both cases, the detected signal scales inversely with A, implying that out-of-focus light at the aperture (or crystal) plane is rejected. A distinct advantage of using a SHG crystal instead of a pinhole is that it has a large area, allowing it to play the role of an aperture even when the transmitted signal light is not de-scanned. That is, the crystal may be thought of as a self-aligned virtual pinhole.

We demonstrate the above principle with the experimental setup shown in FIG. 1. We use a mode-locked Ti:Sapphire laser (Spectra-Physics) to generate laser pulses at 860 nm wavelength, ˜100 fs duration, and 82 MHz repetition rate, that are focused into a target sample with a 60_{—}0.9 N.A. water-immersion objective (Olympus; focal waist w₀=0.5 μm). The transmitted light is collected with an identical objective and refocused onto a Type I, 200 μm thick lithium triborate crystal (Castech). The total magnification factor, M, from the sample to the crystal is approximately 30, leading to a confocal parameter at the crystal of about 800 μm (ie. the crystal is thin relative to this confocal parameter). The laser power incident on the sample, P₀, is typically 10 mW. The laser beam is raster scanned in the x-y direction with galvanometer mounted mirrors, and the sample is scanned in the z direction with a motorized translation stage.

To begin, we consider the signal obtained from a single isolated scatterer, a latex bead, which we scan in the z direction, yielding the axial point-spread-function of our apparatus (z=0 denotes the focal plane). We first observe that, in our imaging configuration, the phase of the scattered light at the crystal plane is approximately in quadrature with that of the unscattered light, independently of the bead position z. This result is a consequence of the cumulative Guoy shifts incurred by both the scattered and unscattered beams before they reach the crystal plane (when z>>w₀²/λ the scattered beam incurs no net Guoy shift). To a good approximation, the total intensity incident at the crystal plane is then simply given by the sum of the respective unscattered and scattered intensities:
I(r,z)=P₀((1−ε_{z})W₀(r)+ε_{z}ηW_{S}(r,z)), (1)
where r is the radius from the optical axis at the crystal plane (we assume cylindrical symmetry), ε_{z}P₀ is the total power scattered by the bead, η is the fraction of this power accepted by the microscope exit pupil (defined here by the collection objective), and W_{0,S}(r) are flux densities normalized so that 2π∫W_{0,S}(r)r dr=1. These functions allow us to define the characteristic areas A_{1J}=(2π∫W₁(r)W_{J}(r)r dr)⁻¹. Since the SHG produced by the crystal is proportional to ∫I²(r)r dr, we conclude that

$$\frac{SHG}{{SHG}_{0}} = {( 1 - {ɛ}_{z} )}^{2} + 2 {ɛ}_{z} ( 1 - {ɛ}_{z} ) η \frac{{A}_{00}}{{A}_{0 S}} + {ɛ}_{z}^{2} {η}^{2} \frac{{A}_{00}}{{A}_{SS}} . \qquad ( 2 )$$

Several comments are in order. First, A₀₀/A_{0S} and A₀₀/A_{SS} are smaller than 1, since W₀(r) corresponds to a diffraction limited intensity profile. Second, it is apparent that as far as scattered light is concerned, A₀₀/A_{0S} and A₀₀/A_{SS} play an aperturing role similar to that of the microscope exit pupil. The smaller the values of A₀₀/A_{0S} and A₀₀/A_{SS} both of which depend on z, the less the scattered light contributes to the SHG signal (ie. the more it is rejected). Finally, for purposes of comparison, we note that if the SHG crystal were removed and the power directly detected and squared, the expression for P²/P₀² would be given by (2) with the replacements A₀₀/A_{0S}→1 and A₀₀/A_{SS}→1. In other words, direct detection of power provides no scattered light rejection beyond that of the exit pupil.

FIG. 2 illustrates SHG/SHG₀ and P²/P₀² for a z-scan of a 530 nm diameter bead. In both cases, the presence of the bead is recognized as a reduction in unscattered laser power (first term in Eq. 2). This reduction is undermined by the concurrent detection of forward-directed scattered power that is transmitted through the exit pupil, which we refer to as background (second and third terms in Eq. 2). Because background rejection is more efficient with SHG than with direct detection, our method leads to a more highly contrasted bead signal.

The parameters in Eq. 2 can be roughly estimated in a paraxial approximation by assuming that W₀(r) and W_{S}(r,z) are Gaussian in profile, leading to A₀₀≈M²πw₀², A_{SS}≈M²πw_{S}²(1+(λz/π_{S}²)²), and A_{0S}=(A₀₀+A_{SS})/2, where w_{S} is the effective bead radius as it appears through the microscope exit pupil. The scattering parameter ε_{z} is dependent on z since it depends on the laser intensity incident on the bead. Denoting σ as the bead scattering cross-section, then ε_{z}≈σ/U_{z}, where

$${U}_{z} = \frac{1}{2} π {w}_{0}^{2} ( 1 + {( λ z / π {w}_{0}^{2} )}^{2} )$$

is the effective area of the laser beam at the axial position z. The pupil transmission η, on the other hand, is approximately independent of z for small z's. The following estimates are derived from Mie theory: σ≈π×(0.15 μm)², w_{S}≈0.83 μm, and η≈0.75. As is evident from a comparison with experimental data, our Gaussian approximation is overly simplistic and cannot account for the observed ringing in the SHG trace, presumably caused by pupil apodization. Nevertheless, it illustrates a salient principle of our microscopy technique, namely that A₀₀/A_{0S} and A₀₀/A_{SS} are smaller than 1, leading here to an improvement in signal contrast with SHG detection.

To demonstrate that virtual pinhole microscopy with SHG detection also leads to improved out-of-focus background rejection, we acquire a z-stack of x-y scans of a slab of 1 mm latex beads suspended in 0.3% agarose (number concentration N=0.0071 μm⁻³; slab thickness L=170 μm). Since ε_{z} fluctuates randomly for different x-y-z positions in the slab, we write ε_{z}=<ε_{z}>+δε_{z} where the brackets refer to the average over an ensemble of x-y scans. If the scattering beads are randomly distributed in the slab and δz is chosen large enough so that ε_{z} and ε_{z+δz} are uncorrelated, then <ε_{z}>≈Nσδz and <δε_{z}²>≈Nσ²δz/U_{z}. Though these last expressions require σ<<U_{z}, meaning their validity breaks down somewhat in the immediate vicinity of the focal plane, we infer that <ε_{z}>,<δε_{z}²><<1 throughout most of the sample. Eq. (2) then leads to the approximation:

$$\frac{〈 SHG 〉}{{SHG}_{0}} \approx {\prod }_{z = {z}_{slab} - L / 2}^{{z}_{slab} + L / 2} ( 1 - 2 〈 {ɛ}_{z} 〉 ( 1 - {η}_{z} \frac{{A}_{00}}{{A}_{0 S}} ) + \\ 〈 {δɛ}_{z}^{2} 〉 ( 1 - 2 {η}_{z} \frac{{A}_{00}}{{A}_{0 S}} + {η}_{z}^{2} \frac{{A}_{00}}{{A}_{SS}} ) ) , \qquad ( 3 )$$

where z_{slab} is the axial location of the slab center and η_{z} is no longer assumed to be constant since |z| can be large. Expression 3 is readily evaluated with the substitution

$${\prod }_{z}^{} ( 1 - f ( z ) δ z ) \approx exp ( - {\int }_{z} f ( z ) δ z ) , yielding \frac{〈 SHG 〉}{{SHG}_{0}} \approx exp ( - 2 N σ {\int }_{{z}_{slab} - L / 2}^{{z}_{slab} + L / 2} ( 1 - {η}_{z} \frac{{A}_{00}}{{A}_{0 S}} - \frac{σ}{2 {U}_{z}} ) δ z ) , \qquad ( 4 )$$

where only the dominant terms have been kept. Relation 4 can be analytically expressed when using the Gaussian approximation. Again for comparison, we note that in the case of direct detection

$$\frac{{〈 P 〉}^{2}}{{P}_{0}^{2}} \approx exp ( - 2 N σ {\int }_{{z}_{slab} - L / 2}^{{z}_{slab} + L / 2} ( 1 - {η}_{z} ) δ z ) . \qquad ( 5 )$$

In particular, we observe that SHG detection is sensitive to δε_{z}² whereas direct detection is not.

FIG. 3 illustrates both SHG and direct detection signals, averaged over x-y, for different values of z_{slab}. The qualitative difference in the traces is striking. The large but gradual increase in <P>² as the slab approaches the focal plane indicates that a significant fraction of the transmitted power consists of out-of-focus scattered light. This is expected from the fact that the scattering is mostly forward directed (η_{z}≈0.9 near the focal plane). As is manifest from FIG. 3, the slab displacement must be quite large (|z_{slab}|>400 μm) before scattered light is significantly rejected by the exit pupil. In contrast, out-of-focus scattered light is much more efficiently rejected when using SHG detection because A₀₀/A_{0S} tends towards zero for relatively small displacements from the focal plane (see FIG. 2). When complete rejection is achieved, only unscattered light produces signal, and <SHG> and <P>² are both proportional to e^{-2NσL}, which is z-independent. The apparent plateau in the SHG trace stems from the fact that A₀₀/A_{0S} and δε_{z}² are non-negligible only when the slab spans the focal plane. This plateau clearly identifies the slab boundaries, demonstrating the advantage of improved out-of-focus background rejection with SHG detection.

Finally, for purposes of illustration, we use our virtual pinhole technique to image an onion slice submerged under a 200_m suspension of 1_m latex beads (number concentration N=0.0048 μm⁻³). The <SHG> image and the corresponding <P>² image are shown in FIG. 4. The former exhibits both a marked improvement in signal contrast and a suppression of speckle noise presumably caused by scattered background.

In conclusion, we have demonstrated a new implementation of transmitted light CLSM where an SHG crystal serves as a self-aligned virtual pinhole. Because the SHG signal scales inversely with the area of the incident light distribution, it preferentially reveals unscattered (focused) rather than scattered (diffuse) transmitted power. We emphasize that our technique works well provided an adequate supply of unscattered light survives transmission through the sample. The fact that unscattered power decays exponentially with sample thickness imposes limits on the technique's applicability. In particular, for thick samples, SHG signal from unscattered light can easily be dominated by SHG from scattered background, despite the suppression of the latter by the virtual pinhole effect. We have empirically observed, with samples comprising 1_m beads, that our technique is effective up to sample thicknesses of roughly 3/Nσ (ie. 3 scattering lengths).

A notable advantage of our technique lies in its ease of implementation, particularly in combination with standard two-photon excited microscopy, which can be operated simultaneously. Finally, we note that our technique is not limited to signal conversion with an SHG crystal. Alternative techniques involving, for example, 2-photon excited fluorophores or wide-bandgap semiconductors could achieve similar virtual pinhole effects.

We also describe a simple and robust technique for transmission confocal laser scanning microscopy wherein the detection pinhole is replaced by a thin second-harmonic-generation crystal. The advantage of this technique is that self-aligned confocality is achieved without a need for signal de-scanning. We derive the point-spread function of our instrument, and quantify both signal degradation and background rejection when imaging deep within a turbid slab. As an example, we consider a slab whose index of refraction fluctuations exhibit Gaussian statistics. Our model is corroborated by experiment.

A pulsed infrared laser beam is focused through a sample and then imaged (re-focused) onto the crystal. A short-pass filter is placed immediately behind the crystal such that only second-harmonic generation (SHG) is detected. Because the SHG power is inversely proportional to the effective area of the laser spot incident on the crystal, the crystal acts as a virtual pinhole, producing a large signal only when the laser spot is tightly focused, similarly to a physical pinhole. The notable advantage of this technique is that virtual confocality is ensured regardless of where the laser spot is focused onto the crystal, meaning that fast beam scanning is allowed without any need for elaborate de-scanning. We call such an instrument an auto-confocal microscope (ACM).

We presented in the first embodiment a cursory description of an ACM based on quadratic detection and valid for thin samples only. Our goal here is to characterize the imaging properties of such an ACM for both thin and thick samples. In this embodiment, we consider a semi-transparent sample and derive the ACM point-spread function (PSF) for both absorbing and phase-shifting point objects. We qualitatively argue that optical sectioning is obtained only to the extent that scattered background is incoherent. Then we will extend our discussion to thick samples, and explicitly quantify the degree to which ACM rejects scattered background—a fundamental property of confocal microscopy. For simplicity, we consider only non-absorbing media, which we characterize by a (real) refractive index auto-correlation function. Finally, we theoretically evaluate the capacity of an ACM to distinguish a localized object of interest embedded within a turbid slab, assuming the refractive index fluctuations in the slab obey Gaussian statistics.

The basic layout of our ACM is shown in FIG. 5. A laser beam, depicted here as a point source, is focused into a sample by a lens of numerical aperture sin α. A second lens re-focuses this focal spot onto a thin nonlinear crystal. We consider the case of a parfocal geometry wherein the lenses are identical and of unit magnification. Generalizations to non-identical lenses or non-unity magnifications are straightforward and will not be considered here. Our goal in this section is to derive the PSF of an ACM, and discuss its capacity for axial sectioning. We consider a semi-transparent sample and begin by deriving the intensity distribution incident on the image plane (ie. on the nonlinear crystal).

For ease of notation, we drop all scaling constants throughout this paper. Following the usual notational convention, we write the PSF's of the lenses as

$$h ( {v}_{1} , {u}_{1} ) = \int P ( \hat{i} ) {ⅇ}^{- ⅈ {v}_{1} \cdot \hat{i}} exp ( i {u}_{1} ( \frac{1}{4} {sin}^{2} ( α / 2 ) - {ξ}^{2} / 2 ) ) ⅆ \hat{i} \qquad ( 1 )$$

where we adopt the axial and radial optical units u₁=4 k z sin²(α/2) and v₁=k ñ sin α, respectively, and k is the wave-vector in the sample medium. We assume the lenses are ideal and possess no aberrations. That is, the coordinates of the lens pupil functions P(\hat{l}) are normalized such that P(ξ≦1)=1 and P(ξ>1)=0.

To determine the SHG power produced by the crystal, we evaluate the electric field at the image plane, given by
U(v)=∫h(v₁,u₁)t(v₁,u₁)h(v−v₁,−u₁)dv₁du₁ (2)
where t(v₁,u₁) is the 3-dimensional object transmission function, and we neglect multiple scattering since we consider here only semi-transparent samples.

We begin by treating the simplest case of a completely transparent sample that produces no scattering. In this case t(v₁,u₁)=δ(u₁) and the field distribution at the image plane becomes
U₀(v)=∫h(v₁,0)h(v−v₁,0)dv₁=h(v,0) (3)

Accordingly, the intensity distribution at this plane becomes
I₀(v)=|U₀(v)|²=∫P(\hat{l}₁)P(\hat{l}₂)e^{-iv·(\hat{l}}^{₁}^{-\hat{l}}^{₂}⁾d\hat{l}₁d\hat{l}₂ (4)

Eq. 4 represents a ballistic light distribution, since it is arises from unscattered transmitted laser light only. Making use of the variable changes \hat{l}_{c}=(\hat{l}₁+\hat{l}₂)/2 and \hat{l}_{d}=\hat{l}₁−\hat{l}₂, we note that I₀(v) is the Fourier transform of the function:
H₀(\hat{l}_{d})=∫P(\hat{l}_{c}+\hat{l}_{d} /2)P(\hat{l}_{c}−\hat{l}_{d}/2)d\hat{l}_{c} (5)

Eq. 5 is the diffraction limited optical transfer function (OTF) of a simple lens. This is expected since our parfocal two-lens system is equivalent to a single lens when the sample is transparent. The functions I₀(v) and H₀(\hat{l}_{d}) will play important roles below.

To derive the PSF in our microscope configuration, we suppose that our sample now contains a single point perturbation located at the position (v_{ε},u_{ε}). That is, we write⁷:
t(v₁,u₁;v_{ε},u_{ε})=δ(u₁)−εδ(v₁−v_{ε})δ(u₁−u_{ε}) (6)
where |ε| is the modulus of the transmission perturbation, assumed small. The real part of ε corresponds to an absorption perturbation whereas the imaginary part corresponds to a phase perturbation. For simplicity, we assume that the sample is scanned in 3-dimensions, with the understanding that formally equivalent results are obtained if the beam is scanned instead of the sample. The perturbed intensity distribution at the image plane is
I(v;v_{ε},u_{ε})=|U₀(v)−εU_{ε}(v;v_{ε},u_{ε})|² (7)
where
U_{ε}(v;v_{ε},u_{ε})=h(v_{ε},u_{ε})h(v−v_{ε},−u_{ε}) (8)
and, accordingly, resultant SHG power produced by the crystal is
SHG(v_{ε},u_{ε})=∫I²(v;v_{ε},u_{ε})dv=S₀+4Re[εS₁(v_{ε},u_{ε})]+ (9)
expanded only to the first order perturbation in ε.

The zeroth order ballistic component is defined by
S₀=∫|U₀(v)|⁴dv=∫I₀²(v)dv=∫H₀²(ξ_{d})d\hat{l}_{d} (10)
where \hat{l}_{d} is interpreted as a normalized spatial frequency, and the last equality is an expression of Parseval's theorem.

The first order term, corresponding to the product of a scattered and three ballistic fields, is defined by
S₁(v_{ε},u_{ε})=∫I₀(v)U₀(v)U*_{ε}(v;v_{ε},u_{ε})dv (11)

As is apparent from Eq. (11), the function I₀(v) plays an identical role here as a pinhole transmission function in standard confocal microscopy—hence the appellation “auto-confocal microscopy”for our technique.

FIG. 6 depicts various PSF's obtained for purely absorbing or phase shifting perturbations. We recall that the function I₀(v) represents the distribution of ballistic light at the crystal plane. As defined by Eq. 4, I₀(v) is the Airy function (J₁(v)/v)² whose effect, as observed from FIG. 6, is essentially identical to that of a standard TCLSM. When using an amplitude perturbation, the contrast S₁/S₀ of our ACM is found to be the same as that of a standard TCLSM whose pinhole radius is 1.65 optical units. This comparison provides a convenient estimate for the effective pinhole size of our ACM.

The theoretical results shown in FIG. 6 may be compared with the experimental results of first embodiment, bearing in mind that the point perturbation in this reference (a latex bead) provoked both a phase-shift and an effective absorption, since the light scattered by the bead was partially clipped by the lens pupil.

We also note that while a pure phase shifting perturbation does not change the total power incident on the image plane, it can, according to FIG. 6c lead to an increase in power transmitted through a finite (but non-zero) size pinhole.

It is well known that the main advantage of confocal fluorescence microscopy is its capacity for out-of-focus fluorescence background rejection. In particular, a uniformly fluorescent transverse slice produces a signal that scales as uₛ⁻², where uₛ is its axial distance from the focal plane. Such a scaling law, which is necessary for optical sectioning, applies even in a transmission geometry because of the incoherent (random phase) nature of fluorescence emission.

However, there is a fundamental difference between TCLSM's that are based on fluorescence and on transmission. Whereas a fluorescence microscope exhibits a dark background in the absence of a sample, an ACM, in contrast, exhibits a bright background, stemming from the term S₀ in Eq. 9. This background cannot be easily eliminated. Moreover, the capacity of an ACM for optical sectioning is sample dependent. This problem is readily apparent if one considers simple samples such as a uniformly phase-shifting or absorbing transverse slice. The ACM signals produced by either of these samples is independent of uₛ and no optical sectioning is possible (this inability to reject a uniform background is sometimes referred to as the “missing-cone” problem).

However, samples of interest are rarely so simple. If one considers a transverse slice that instead produces locally random phase-shifts or absorptions (about a mean), the signal produced by an ACM then crucially depends on uₛ. The transmittance of such samples can be written as

$$t ( {𝓋}_{1} , {u}_{1} ; {u}_{s} ) = δ ( {u}_{1} ) + {\sum }_{n} {ɛ}_{n} δ ( {𝓋}_{1} - {𝓋}_{{ɛ}_{n}} ) δ ( {u}_{1} - {u}_{s} ) \qquad ( 12 )$$

where infinitesimally small area elements are summed, characterized by complex perturbations εₙ that are randomly distributed in phase. Insertion of Eq. 12 into Eq. 9 leads to a cancellation of the S₁ term, leaving the second order term as a sample dependent response. Such a response exhibits optical sectioning since it scales with uₛ in the same way as a fluorescence confocal response. In effect, by imposing random phases to εₙ we have mimicked the incoherence of a fluorescence signal. We note that, while our argument assumes that each perturbation εₙ covers an infinitesimally small area, it remains valid even for finite area perturbations, provide these are small relative to the local laser-beam spot size. Hence, even though the optical sectioning may not be as tightly confined as with a standard fluorescence confocal microscope, it remains nonetheless confined since the laser spot-size expands with increasing |uₛ|.

In practice, samples of interest are often highly scattering, leading to severe limitations on imaging depth. Our goal in this section is to quantify these limitations by extending our above analysis to thick samples. We consider an intermediate regime often encountered in biological imaging wherein light propagating through a sample is neither wholly ballistic nor wholly diffusive. In particular, we consider scattering that is dominantly forward directed. Such scattering arises from samples that provoke local phase variations that do not significantly deflect the light field but nonetheless highly degrade image quality. We adopt the geometry shown in FIG. 3. The sample consists of a slab of thickness L, in which a small object of interest is embedded. As in Section II.B, we suppose the object provokes a localized amplitude or phase perturbation whose signal we wish to evaluate. We derive both signal and background as a function of slab position (or, equivalently, object depth). For simplicity, we assume that the object is situated exactly at the focal point, and that the slab medium is non-absorbing, homogeneous, and isotropic. These assumptions allow us to emphasize the main features of our results, though they are not fundamental to our analysis.

As is apparent from FIG. 7a, the sample may be thought of as two adjacent semi-slabs of thicknesses L_{A} and L_{B}, situated respectively before and after the object plane. By assumption, back-scattered light is neglected and we assume the light traversing these semi-slabs travels from left to right only. The semi-slabs provoke random phase variations in the light field whose effects can be examined separately: semi-slab A de-focuses the light as it propagates to the object plane, while semi-slab B further de-focuses the light as it continues to propagate to the image plane. Bearing this picture in mind, we develop a formalism based on the alternative equivalent geometry shown in FIG. 7b, where we project the phase variations provoked respectively by semi-slabs A and B into the pupil functions of the corresponding lenses. In other words, we mimic the de-focusing effects of the semi-slabs by introducing lens aberrations, and write:
P_{A,B}(\hat{l})→P(\hat{l})e^{iδφ}^{_{A,B}}^{(\hat{l})} (13)

The statistics of these aberrations must be correctly defined so as to properly match those of the semi-slabs. We will discuss how to define these statistics. For now, we assume the lens aberrations are characterized by their auto-correlation function, which, by assumption of transverse homogeneity and isotropy, is a function only of the distance between the aberration coordinates. We write, for lens A,
Γ_{φ}^{(A)}(ξ_{d})=<δφ_{A}(\hat{l}₁)δφ_{A}(\hat{l}₂)> (14)
where \hat{l}_{d}=\hat{l}₁−\hat{l}₂ and the brackets correspond to an ensemble average, and we assume Γ_{φ}^{(A)}(ξ_{d})→0 for ξ_{d} sufficiently large. A similar equation applies to lens B. Also, since the phase variations provoked by the semi-slabs are assumed to be uncorrelated, then <δφ_{A}(\hat{l}₁)δφ_{B}(\hat{l}₂)>=0.

Before deriving the signal produced by an isolated perturbation of interest, we derive the associated background in the absence of any specific perturbation. As previously, we must calculate the field U₀ at the image plane. This time, however, we take into account the phase shifts incurred by the light upon propagation through the entire slab thickness. These are δφ_{L}(\hat{l})=δφ_{A}(\hat{l})+δφ_{B}(\hat{l}). By correspondence with Eqs. 1 and 3, we write
U₀(v)→∫P(\hat{l}₁)e^{-iv\hat{l}}^{₁}e^{iδφ}^{_{L}}^{(\hat{l}}^{₁}⁾d\hat{l}₁ (15)
leading to
S₀=∫P(\hat{l}₁)P(\hat{l}₂)P(\hat{l}₃)P(\hat{l}₄e^{-iv·(\hat{l}}^{₂}^{+\hat{l}}^{₃}^{-\hat{l}}^{₄}⁾K_{L}^{1,2,3,4}d\hat{l}₁d\hat{l}₂d\hat{l}₃d₄dv (16)
where we have defined
K_{L}^{1,2,3,4}=exp [i(δφ_{L}(\hat{l}₁)−δφ_{L}(\hat{l}₂)+δφ_{L}(\hat{l}₃)−δφ_{L}(\hat{l}₄))] (17)

Since we are concerned here with a typical background, we perform an ensemble average of K_{L}^{1,2,3,4}. By assumption, the slab is thick enough that δφ_{L} represents a sum of many independent phase variations, and we write

$$〈 {K}_{L}^{1 , 2 , 3 , 4} 〉 = exp ( - \frac{1}{2} {\sum }_{i , j} {( - 1 )}^{i + j} 〈 {δϕ}_{L} ( {\hat{i}}_{i} ) {δϕ}_{L} ( {\hat{i}}_{j} ) 〉 ) \qquad ( 18 )$$

where we have invoked the Central Limit Theorem and made use of the relation

$$〈 exp ( i δϕ ) 〉 = exp ( - \frac{1}{2} 〈 {δϕ}^{2} 〉 )$$

valid for Gaussian variables.

An integration of Eq. 16 over the variable v imposes the constraint \hat{l}₁−\hat{l}₂=\hat{l}₄−\hat{l}₃, leading to the simplification

$$〈 {K}_{L}^{1 , 2 , 3 , 4} 〉 = {H}_{L}^{2} ( {ξ}_{d} ) exp [ - \frac{1}{2} {\sum }^{′} ] \qquad ( 19 )$$

where
Σ′=<δφ_{L}(\hat{l}₁)δφ_{L}(\hat{l}₃)>−δφ_{L}(\hat{l}₁)δφ_{L}(\hat{l}₄>+<δφ_{L}(\hat{l}₂)δφ_{L}(\hat{l}₄)<−>δφ_{L}(\hat{l}₂)δφ_{L}(\hat{l}₃)< (20)
and we have introduced the transfer function
H_{L}(ξ_{d})=exp(−Γ_{φ}^{(L)}(0)+Γ_{φ}^{(L)}(ξ_{d})) (21)

The exponent in Eq. 21 is often referred to as (twice) the structure function of the phase variations \hat{l}. The physical meaning of H_{L} will be elaborated on below. We note here that if the slab is transparent (or nonexistent), then H_{L}(ξ_{d})=1 for all ξ_{d}. If, instead, the slab is thick enough to provoke significant phase variations, then H_{L}(ξ_{d}) rapidly decays from unity at ξ_{d}=0 to a small baseline value exp(<Γ_{φ}^{(L)}(0) (see FIG. 4). We define below what we mean by “significant” and assume for now that H_{L} is sufficiently peaked around the origin that H_{L}² takes on non-negligible values in Eq. 19 only when ξ_{d}≈0. As a result, the main contribution in the integration in Eq. 16 comes from the region where <K_{L}^{1,2,3,4}>≈H_{L}²(ξ_{d}). We then obtain
<S₀>≈∫P(\hat{l}_{c}+\hat{l}_{d}/2)P(\hat{l}_{c}+\hat{l}_{d}/2) P(\hat{l}′_{c}−\hat{l}₂/2)P(\hat{l}′_{c}−\hat{l}_{d}/2)H_{L}²(ξ_{d})d\hat{l}_{c}d\hat{l}_{c}′d\hat{l}_{d} (22)
which, with Eq. 5, simplifies to,
<S₀>≈∫H₀²(ξ_{d})H_{L}²(ξ_{d})d\hat{l}_{d} (23)

<S₀> is the average background SHG power obtained when only the slab is taken into account and nothing more (ie. no object of interest lies at the focal center). A comparison of Eq. 23 with Eq. 10 suggests that H_{L}(ξ_{d}) can be interpreted as a filter function similar to H₀(ξ_{d}). By limiting the extent of the spatial frequencies that are transferred to the image plane, H_{L}(ξ_{d}) provokes a blurring of the focal spot incident on the SHG crystal. Hence, though the presence of the slab does not alter the total power incident on the crystal, it does lead to a reduction in the resultant SHG the crystal produces. The intrinsic sensitivity of nonlinear detection to de-focusing is the basis of ACM background rejection.

We now derive the signal produced by point object located at the focal center. We use the same formalism developed above for deriving background, but this time we treat the semi-slabs individually. Referring to Eq. 8, and explicitly identifying the respective phase aberrations in lenses A and B, we write,
U_{ε}(v)→∫P(\hat{l}₁)P(\hat{l}₂)e^{-v·\hat{l}}^{₂}e^{i(δφ}^{_{A}}^{(\hat{l}}^{₁}^{)+δφ}^{_{B}}^{(\hat{l}}^{₂}⁾⁾d\hat{l}₁d\hat{l}₂ (24)

We will restrict our analysis here to the first order perturbation for both absorption and phase contrasts. This first order signal (Eq. 11) becomes
S₁=∫P(\hat{l}₁)P(\hat{l}₂)P(\hat{l}₃)P(\hat{l}₄)P(\hat{l}₆)e^{-iv·(\hat{l}}^{₁}^{-\hat{l}}^{₂}^{+\hat{l}}^{₃}^{-\hat{l}}^{₆}⁾ K_{A}^{1,2,3,4,}K_{B}^{1,2,3,6}d\hat{l}₁d\hat{l}₂d\hat{l}₃d\hat{l}₄d\hat{l}₆dv (25)
where we have used definitions for K_{A} and K_{B} similar to Eq. 17 and adjusted our indices in accord with Eq. 18. An integration over the variable v leads to the constraint \hat{l}_{d}=\hat{l}₁−\hat{l}₂=\hat{l}₆−\hat{l}₃ and, following the same reasoning as in the previous section, we obtain
<K_{B}^{1,2,3,6}>≈H_{B}²(ξ_{d}) (26)
<K_{A}^{1,2,3,4}>≈H_{A}(ξ_{d})H_{A}(ξ′_{d}) (27)
where we have defined \hat{l}′_{d}=\hat{l}₃−\hat{l}₄ and have assumed that H_{B}²(ξ_{d}) is non-negligible only for small ξ_{d}, as before, leading to the restriction \hat{l}₆≈\hat{l}₃. The signal produced by a localized amplitude perturbation is then given by
<S₁>≈∫H₀(ξ′_{d})H_{A}(ξ′_{d})d\hat{l}′_{d}∫H₀(ξ_{d})H_{B}²(ξ_{d})H_{A}(ξ_{d})d\hat{l}_{d} (28)

We note that Eq. 28 resembles Eq. 23 except that a component of the light transmitted through semi-slab A prior to its interaction with the object has been isolated (first integral). We also remind the reader that S₁ reveals a phase gradient rather than a phase exactly at the focal center (see FIG. 6c).

Eqs. 23 and 28 are the main results of this section, and represent formal expressions for the background and highest order signal obtained when using a quadratic detection ACM to image inside a thick slab.

So far, we have made no assumptions on the detailed nature of the phase fluctuations introduced by the slab. We consider here the specific example where these are produced by refractive index fluctuations that obey locally Gaussian statistics. Such statistics are routinely used to describe scattering media, and are particularly convenient because of their tractability. To this end, we define a transverse autocorrelation function for the refractive index fluctuations,
<δn(\tilde{n}₁)δn(ñ₂)>=<δn²> exp(−ρ_{d}²/lₙ²) (29)
where we have reverted to the lab-frame coordinate system (ñ,z) relative to the focal center, and lₙ is a characteristic fluctuation scale, assumed to be the same in all three dimensions. If light propagates an axial distance δz<<lₙ, it incurs a phase shift kδz. On the other hand, for longer axial distances δz>>lₙ then the phase shift is no longer proportional to the propagation distance but instead performs a random walk with step size≈klₙ. In this latter case the variance of the phase fluctuations, as opposed to their amplitude, scales linearly with axial propagation distance, and we write
Γ_{φ}^{(δz)}(ρ_{d})≈δzlₙk²>δn(ñ₁)δn(ñ₂) > (30)
where ñ_{d}=ñ₁−ñ₂, and δz is assumed to be small enough that we may neglect beam convergence or divergence.

As described above, we use the technique of projecting the slab fluctuations into the lens pupils, which requires the coordinate transformation ρ_{d}→ξ_{d}z sin α. Referring to Eq. 21, we obtain then,
H_{δz}(ξ_{d})≈exp(−δzσ_{φ}²(1−γ_{φ}^{(δz)}(ξ_{d}z sin α))) (31)
where σ_{φ}²≈k²lₙ<δn²> is the variance of the phase fluctuations per unit propagation distance, and we define γ₁₀₀ ^{(δz)}(ρ_{d})=Γ_{φ}^{(δz)}(ρ_{d})/Γ_{φ}^{(δz)}(0). We note that γ_{φ}^{(δz)}(ρ_{d}) is always
equal to one at the origin, but becomes more and more narrowly peaked as the propagation distance through the slab increases.

To derive the filter function through a thick slab, not just a thin slice, we must take beam convergence or divergence into account. Since the filter functions for sequential slices of thickness δz are assumed to operate independently, we make the approximation
H_{L}(ξ_{d})≈Π_{L}H_{δz}(ξ_{d}) (32)

This last step represents one of the main advantages of our having projected the phase fluctuations from the slab (spatial coordinates) to the lens pupils (frequency coordinates) where the filter functions operate multiplicatively.

Expression 32 is a product over the entire slab thickness, and can be evaluated by integrating the exponent in Eq. 31. We obtain the approximate expression
H_{L}(ξ_{d})≈exp(−Lσ_{φ}²)+(1−exp(−Lσ_{φ}²) exp(−ξ_{d}²σ_{φ}²V/lₙ²) (33)
where we have defined V=∫_{L}(z sin α)²δz, which roughly corresponds to the volume of the laser beam inside the slab (shaded region in FIG. 3a). As described in section III.A and is explicit in Eq. 33, H_{L}(ξ_{d}) consists of a spatial-frequency-independent baseline (first term) onto which a narrow peak around the origin (second term) is superposed (see FIG. 8). The physical meaning of these terms is as follows:

H_{L}(ξ_{d}) represents the effect of the slab on the transmitted beam. This effect is two-fold. The baseline term in Eq. 33 is an expression of Lambert's law and describes the frequency-independent attenuation of the ballistic (non-scattered) light transmitted through the slab. With this interpretation, the scattering mean-free-path (MFP) of the slab is defined as lₛ=σ_{φ}⁻². The peak term in Eq. 33 represents the effect of H_{L}(ξ_{d}) on the rest of the light transmitted through the slab that has been scattered. Whereas very low spatial frequencies are efficiently transmitted, frequencies higher than a cut-off ξ_{3 dB}≈lₙ\sqrt{lₛ/V} are severely attenuated. We remind the reader that a diffraction-limited focus requires a transmission of frequencies up to ξ_{d}≈1. Hence, inasmuch as ξ_{3 dB}<<1 (we will quantify this below), the second term in H_{L}(ξ_{d}) leads to a significant blurring of the non-ballistic light at the image plane.

We now directly evaluate the background produced by the SHG crystal. For convenience, we make two approximations. First, even though H₀(ξ_{d}), as defined by Eq. 5, can be expressed analytically, we adopt the much simpler Gaussian beam approximation H₀(ξ_{d})≈exp(−ξ_{d}²), which is valid in the paraxial limit. Second, we relate lₙ to the more experimentally accessible transport MFP, defined by l*ₛ=lₛ/(1−< cos θₛ>), where θₛ is the deflection angle occasioned by a single scattering event. For Gaussian refractive index fluctuations (Eq. 29), these are approximately related by k²lₙ²≈l*ₛ/lₛ. As an example, lₙ is on the order of a micron for most biological tissues of interest, meaning that the scattering is highly forward directed at optical wavelengths and l*ₛ is typically 10 to 20 times longer than lₛ.

Using Eq. 33 and performing the integral in Eq. 23, we obtain
<S₀>≈SHG₀{ exp(−2L/lₛ)+(1−exp(−2L/lₛ))R(l*ₛ,V)} (34)
where SHG₀ corresponds to the SHG power obtained if there were no slab (L=0). As discussed above, the effect of the slab is to convert non-scattered ballistic light into scattered light. The thicker the slab, the more this conversion is complete, and the first and second terms in Eq. 34 correspond to these ballistic and non-ballistic components respectively. However the non-ballistic component is significantly rejected here by the factor

$$R ( {l}_{s}^{*} , V ) = ( \frac{{l}_{s}^{*}}{{l}_{s}^{*} + {k}^{2} V} ) \qquad ( 35 )$$

This rejection factor is a fundamental consequence of the fact that de-focused non-ballistic light is ineffective in producing SHG. The greater the de-focusing, the greater the rejection, as indicated by the relation R(l*ₛ,V)≈ξ_{3 dB}². Moreover, the rejection depends only on the intrinsic slab parameter l*ₛ, and on extrinsic parameters such as slab thickness and position along the optical axis, both of which govern the interaction volume through the geometric relation

$$V = {V}_{A} + {V}_{B} \approx \frac{{sin}^{2} α}{3} ( {L}_{A}^{3} + {L}_{B}^{3} ) \qquad ( 36 )$$

An illustration of R for different V's is shown in FIG. 9. In this experimental example, the slab is thick enough that the ballistic component can be neglected, meaning <S₀<≈R(l*ₛ,V). We emphasize that even when the interaction volume is at a minimum here (slab is centered on focal plane), the rejection factor still remains considerably smaller than one, indicating that non-ballistic light is highly de-focused and justifying a posteriori the assumptions that led to Eq. 22. The theoretical fit shown in FIG. 9 contains no free parameters and is remarkably accurate despite the simplicity of Eq. 35. We note that, for this example and those presented henceforth, V is always large enough that we may use the approximation R(l*ₛ,V)≈l*ₛ/k²V.

To evaluate the capacity of our ACM to perform deep imaging in a scattering slab, we consider, as previously, the signal produced by a point perturbation of interest located at the focal center. The depth L_{A} of this perturbation relative to the slab surface is governed by the slab position, which in turn governs L_{B}, V_{A}, V_{B}, and V (only L remains unchanged). Approximating the filter functions in Eq. 28, as was done above to obtain Eq. 33, we arrive at

$$〈 {S}_{1} 〉 ∝ \{ exp ( - {L}_{A} / {l}_{s} ) + ( 1 - exp ( - {L}_{A} / {l}_{s} ) ) R ( {l}_{s}^{*} , {V}_{A} ) \} \times \{ exp ( - ( L + {L}_{B} ) / {l}_{s} ) + ( 1 - exp ( - ( L + {L}_{B} ) / {l}_{s} ) ) R ( {l}_{s}^{*} , V + {V}_{B} ) \} \qquad ( 37 )$$

The leftmost bracketed terms in Eq. 37 represents the laser intensity incident exactly at the point object, consisting of ballistic and non-ballistic components. The latter component is diminished by the factor R(lₛ,V_{A}) because of spreading of the non-ballistic light.

Using the same apparatus as described in the first embodiment we experimentally corroborate the validity of these results with test slabs consisting of 1 μm latex beads embedded in scattering media (themselves composed of latex beads, some of which are fluorescent, in agarose gels). The parameters lₛ and l*ₛ can be prescribed for each slab based on the sizes and concentrations of the beads. Moreover, the parameter lₛ can easily be verified by monitoring the average two-photon excited fluorescence (TPEF) signal produced by the fluorescent beads, which is known to decay as exp(−2L_{A}/lₛ) to moderate depths.

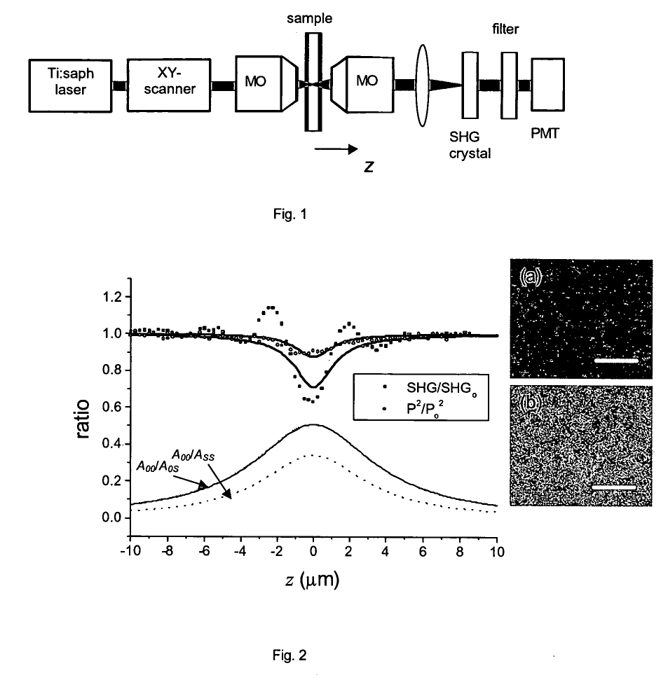

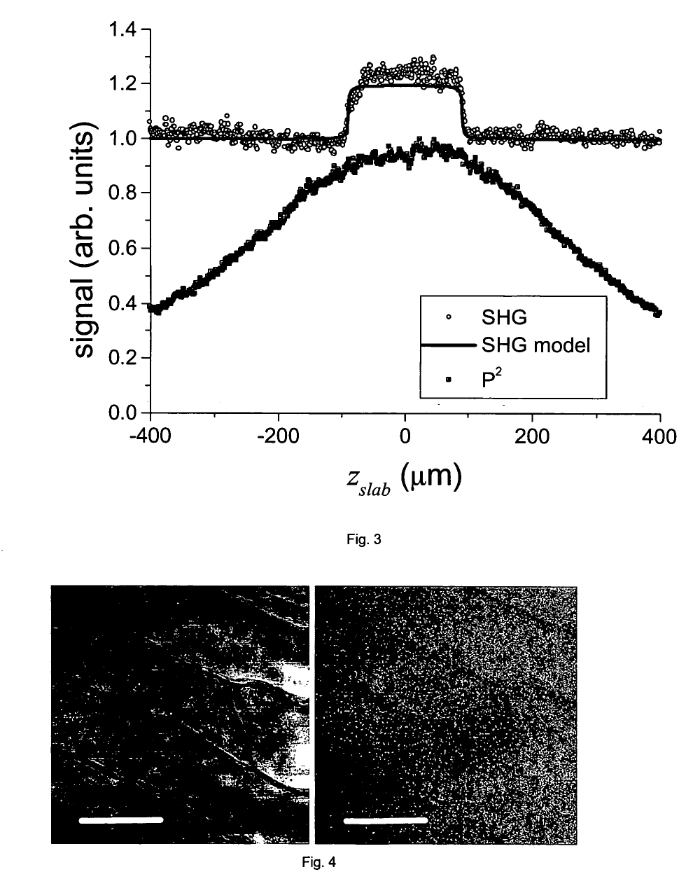

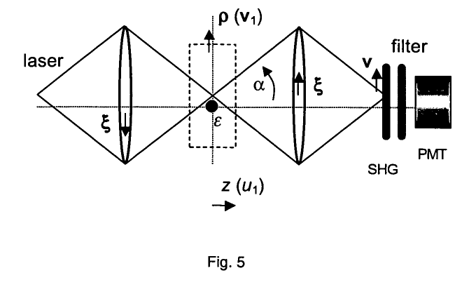

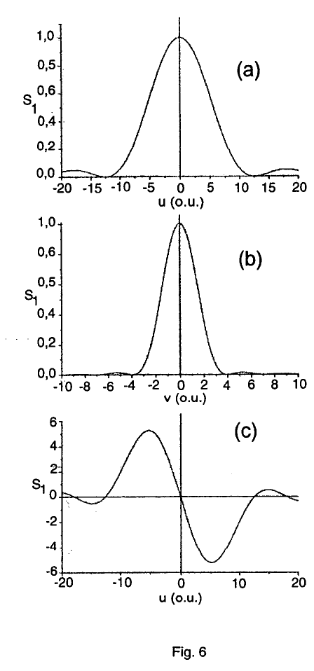

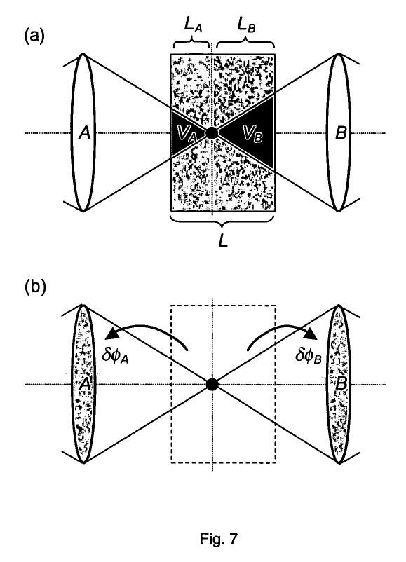

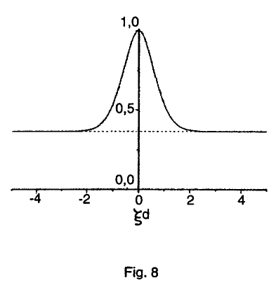

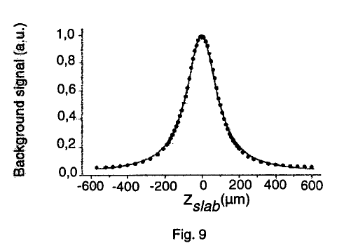

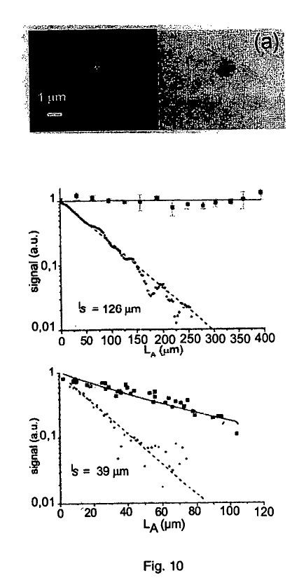

Two regimes may be distinguished, based on the relative contributions of ballistic and non-ballistic components in the average SHG signal (Eq. 34). If the ballistic component is dominant (first term in Eq. 34), then <S₁> is essentially independent of L_{A} or V_{A}, meaning that the signal produced by a point object of interest, whether absorbing or phase-shifting, remains the same at all depths throughout the slab. This regime is illustrated in FIG. 10b.

If, instead, the non-ballistic component is dominant (second term in Eq. 34), then the amount of ballistic light incident of the SHG crystal is negligible. This should not be confused, however, with the amount of ballistic light incident on the point object itself, which can be much greater and lead to contrast. This second regime is illustrated in FIG. 10c. Hence, though only non-ballistic light produces signal in this second regime, high-resolution images can nonetheless be obtained. The signal here decays with object depth. From Eq. 37, we infer the rough scaling law for moderate depths <S₁>∝ exp(−L_{A}/ζlₛ), where the slab MFP has been effectively lengthened by the factor ζ≈1(1−3lₛ/L), valid for L>lₛ. This apparent lengthening of the MFP stems directly from the effectiveness of nonlinear detection in rejecting non-ballistic background. In summary, the main advantages of ACM are that it allows fast beam scanning, provides effective background rejection, and can be readily combined with TPEF microscopy. The performance of an ACM is essentially the same as that of a standard TCLSM. The capacity of an ACM for depth penetration depends on the net amount of ballistic light that traverses the slab. If the slab is thin, then both background and signal are independent of depth. If the slab is thick, then background scales roughly inversely with the light-slab interaction volume while the signal decays moderately with depth, in accord with the simple model presented above.

1. Confocal laser scanning microscopy apparatus, comprising:
means for emitting a laser beam;
means for scanning this laser beam in at least two directions onto an observed sample;
means for generating a non linear light signal from the transmitted laser light, these non linear light signal generating means being disposed in the light path between the observed sample and detecting means which are adapted for detecting said non linear light signal.

2. Confocal laser scanning microscopy apparatus according to claim 1, wherein the generating means are second harmonic laser light generating means, and wherein the detecting means are adapted for detecting said second harmonic laser light.

3. Confocal laser scanning microscopy apparatus according to claim 2, wherein the generating means comprise a second harmonic generating crystal.

4. Confocal laser scanning microscopy apparatus according to claim 3, wherein the crystal is a Type I, lithium triborate crystal.

5. Confocal laser scanning microscopy apparatus according to claim 3, wherein the thickness of the crystal along the light path is roughly equal to 200 micrometers.

6. Confocal laser scanning microscopy apparatus according to claim 3, wherein the lateral dimensions of the crystal are sufficiently large to cover the area scanned by the laser beam.

7. Confocal laser scanning microscopy apparatus according to claim 1, wherein means for scanning are adapted for scanning the laser in two lateral and one longitudinal directions.

8. Confocal laser scanning microscopy apparatus according to claim 1, further comprising a short-pass filter disposed in the light path immediately behind the non linear light signal generating means such that only non linear light signal is detected.

9. Confocal laser scanning microscopy apparatus according to claim 1, wherein the non linear light signal generating means comprise a two-photon excited fluorophore.

10. Confocal laser scanning microscopy apparatus according to claim 1, wherein the non linear light signal generating means comprise a wide-bandgap semiconductor.

11. Confocal laser scanning microscopy apparatus according to claim 1, wherein the emitting means are adapted for emitting laser pulses.
